(19) United States
(12) Patent Application Publication
(10) Pub. No.: US 2015/0145442 A1
(43) Pub. Date: May 28, 2015

(54) CONTROL DEVICE AND CONTROL METHOD FOR HYBRID VEHICLE POWER UNIT

(71) Applicants: Tomohiko Miyamoto, Toyota-shi (JP); Masayuki Ikemoto, Anjou-shi (JP); Mamoru Kuramoto, Toyota-shi (JP); Noriyuki Yagi, Kariya-shi (JP)

(72) Inventors: Tomohiko Miyamoto, Toyota-shi (JP); Masayuki Ikemoto, Anjou-shi (JP); Mamoru Kuramoto, Toyota-shi (JP); Noriyuki Yagi, Kariya-shi (JP)

(73) Assignee: TOYOTA JIDOSHA KABUSHIKI KAISHA, Toyota-shi, Aichi-ken (JP)

(21) Appl. No.: 14/408,074

(22) PCT Filed: Jul. 23, 2013
(86) PCT No.: PCT/IB2013/001879

§ 371 Date: Dec. 15, 2014

(30) Foreign Application Priority Data
Jul. 26, 2012 (JP) 2012-165832

(51) Int. Cl. H02P 5/695

(52) U.S. Cl. CPC H02P 5/695
USPC 318/98

(57) ABSTRACT

A power unit includes a first rotating electrical machine and a second rotating electrical machine as prime movers. The first rotating electrical machine, the second rotating electrical machine and a drive wheel are respectively connected to a ring gear, sun gear and carrier of a planetary gear mechanism. When a temperature of a permanent magnet of the first rotating electrical machine becomes close to a temperature at which demagnetization occurs, an output of the first rotating electrical machine is reduced, and an output of the second rotating electrical machine is increased. Thus, the total output of the power unit is kept.

### BACKGROUND OF THE INVENTION

1. Field of the Invention

The invention relates to control over a hybrid vehicle power unit that includes a plurality of types of prime mover, including a rotating electrical machine.

2. Description of Related Art

There is known a hybrid vehicle that includes an internal combustion engine and a rotating electrical machine as a driving prime mover. In the specification, the “rotating electrical machine” is used as a generic term of electrical devices that function as an electric motor, a generator or both an electric motor and a generator. A rotating electrical machine that uses a permanent magnet (permanent magnet-type rotating electrical machine) is widely employed as a rotating electrical machine used as a vehicle prime mover because it has small-size and high-power characteristics.

A permanent magnet may be demagnetized, that is, the magnetic flux density of a permanent magnet may reduce. A temperature and an external magnetic field are known as a cause of demagnetization. When an opposite external magnetic field is applied to magnetic fluxes that are generated by the permanent magnet, the magnetic flux density of the permanent magnet decreases. In the case where the magnetic flux density of the external magnetic field is small, the magnetic flux density of the permanent magnet returns to an original value when the external magnetic field is removed. However, when the magnetic flux density of the external magnetic field is larger than or equal to a certain value, the magnetic flux density of the permanent magnet does not return to the original value and becomes a value smaller than the original value even when the external magnetic field is removed. That is, demagnetization occurs.

An upper limit of the external magnetic field at or below which such demagnetization does not occur is called coercive force. That is, when the external magnetic field larger than or equal to the coercive force is applied to the permanent magnet, demagnetization occurs. In addition, the coercive force varies depending on a temperature. For example, it is known that the coercive force of a ferrite magnet decreases in a low-temperature range. In addition, it is known that the coercive force of a neodymium magnet decreases in a high-temperature range.

When the permanent magnet of the permanent magnet-type rotating electrical machine is demagnetized, the rotating electrical machine cannot exhibit predetermined performance. Thus, the permanent magnet-type rotating electrical machine needs to be operated in a range in which demagnetization of the permanent magnet does not occur. Therefore, under an operating condition that the coercive force of the permanent magnet decreases and demagnetization occurs, control for suppressing the output of the rotating electrical machine may be executed in order for the magnetic flux density of revolving magnetic fields formed by a stator does not exceed the coercive force. Japanese Patent Application Publication No. 9-289799 (JP 9-289799 A) describes a technique for detecting the temperature of a permanent magnet and then setting an upper limit of a torque command of a rotating electrical machine on the basis of the detected temperature such that demagnetization does not occur.

When the output of the rotating electrical machine is limited in order to prevent demagnetization of the permanent magnet, the power performance of the vehicle decreases. Particularly, when the amount of usage of a rare metal that is added in order to improve coercive force is suppressed, the output needs to be further limited.

### SUMMARY OF THE INVENTION

The invention provides a control device and control method for a hybrid vehicle power unit, which suppresses a decrease in the total output of the power unit even at a temperature at which demagnetization of a permanent magnet of a rotating electrical machine occurs or close to the temperature.

In a first aspect of the invention, a hybrid vehicle power unit includes a first rotating electrical machine connected to a first element of a planetary gear mechanism, a second rotating electrical machine connected to a second element of the planetary gear mechanism and an internal combustion engine connected to the first rotating electrical machine, wherein a third element of the planetary gear mechanism is connected to a drive wheel. The first aspect of the invention relates to a control device for the hybrid vehicle power unit. The control device includes: a temperature acquisition unit that acquires a temperature of a permanent magnet of at least one of the first rotating electrical machine and the second rotating electrical machine; and a control unit that, when the acquired temperature falls outside a predetermined range, reduces an output of one of the rotating electrical machines, which includes the permanent magnet of which the temperature falls outside the predetermined range, and increases an output of the other one of the rotating electrical machines. The hybrid vehicle power unit includes the two rotating electrical machines connected to each other via the planetary gear mechanism. The first rotating electrical machine is connected to the first element of the planetary gear mechanism, the second rotating electrical machine is connected to the second element of the planetary gear mechanism, and the third element of the planetary gear mechanism is connected to the drive wheel. Furthermore, the power unit includes the internal combustion engine connected to the first rotating electrical machine. The control device that controls the operation of the power unit includes temperature acquisition means for acquiring the temperature of the permanent magnet of at least one of the two rotating electrical machines. Furthermore, the control device includes the control unit that, when the temperature acquired by the temperature acquisition means is a temperature that falls outside the predetermined range, that is, a range in which demagnetization of the permanent magnet does not occur, or a temperature close to outside the range, reduces the output of the one of the rotating electrical machines, of which the temperature has been acquired, and increases the output of the other one of the rotating electrical machines. In the first aspect of the invention, the output of the one of the rotating electrical machines may be reduced by reducing an output upper limit of the one of the rotating electrical machines.

Instead of the above-described control unit, it is allowed to employ a control unit that, when the acquired temperature of the permanent magnet falls outside a predetermined range, reduces an output upper limit of the one of the rotating electrical machines, which includes the permanent magnet, and increases an output of the other one of the rotating electrical machines when the output of the one of the rotating electrical machines has been reduced by reducing the output upper limit value. In a second aspect of the invention, a hybrid vehicle power unit includes a first rotating electrical machine connected to a first element of a planetary gear mechanism, a second rotating electrical machine connected to a second element of the planetary gear mechanism and an internal combustion engine connected to the first rotating electrical machine, wherein a third element of the planetary gear mechanism is connected to a drive wheel. The second aspect of the invention relates to a control device for the hybrid vehicle power unit. The control device includes: a temperature acquisition unit that acquires a temperature of a permanent magnet of at least one of the first rotating electrical machine and the second rotating electrical machine; and a control unit that, when the acquired temperature falls outside a predetermined range, reduces an output upper limit of one of the rotating electrical machines, which includes the permanent magnet of which the temperature falls outside the predetermined range, and increases an output of the other one of the rotating electrical machines when the output of the one of the rotating electrical machines has been reduced by reducing the output upper limit value.

In a third aspect of the invention, a hybrid vehicle power unit includes a first rotating electrical machine connected to a first element of a planetary gear mechanism, a second rotating electrical machine connected to a second element of the planetary gear mechanism and an internal combustion engine connected to the first rotating electrical machine, wherein a third element of the planetary gear mechanism is connected to a drive wheel. The third aspect of the invention relates to a control method for the hybrid vehicle power unit. The control method includes: acquiring a temperature of a permanent magnet of at least one of the first rotating electrical machine and the second rotating electrical machine; and, when the acquired temperature falls outside a predetermined range, reducing an output of one of the rotating electrical machines, which includes the permanent magnet of which the temperature falls outside the predetermined range, and increasing an output of the other one of the rotating electrical machines.

According to the aspects of the invention, it is possible to suppress a decrease in the total output of the power unit while preventing demagnetization of the permanent magnet by reducing the output of the rotating electrical machine in which demagnetization is assumed to occur and increasing the output of the other rotating electrical machine.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows the configuration of a hybrid vehicle power unit according to the invention;

FIG. 2 is a view that shows the correlation among outputs of three elements of a planetary gear mechanism;

FIG. 3 is a flowchart that shows a process of preventing demagnetization; and

FIG. 4 is a flowchart that shows another process of preventing demagnetization.

### DETAILED DESCRIPTION OF EMBODIMENTS

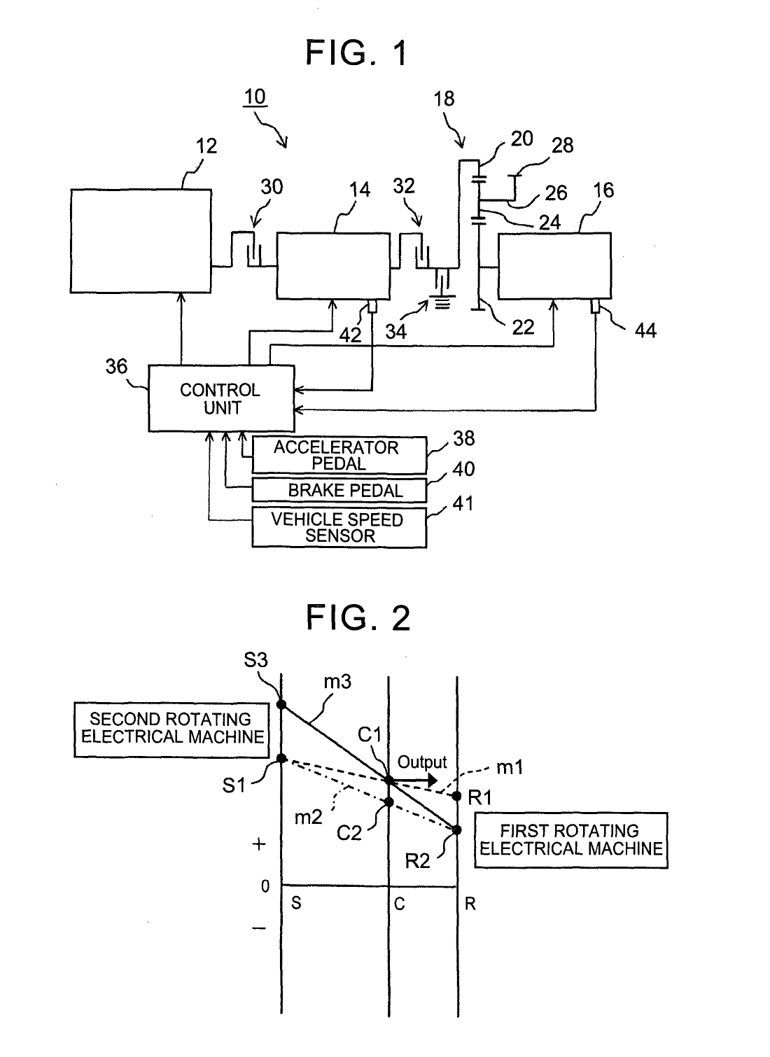

Hereinafter, an embodiment of the invention will be described with reference to the accompanying drawings. FIG. 1 is a block diagram that shows the schematic configuration of a power unit 10 for a hybrid vehicle. The power unit 10 includes three prime movers. One of the prime movers is an internal combustion engine 12, and the remaining two prime movers are rotating electrical machines 14, 16. The internal combustion engine 12 may be, for example, an Otto engine or a diesel engine. In the embodiment, the two rotating electrical machines each are a permanent magnet-type rotating electrical machine that uses a permanent magnet as a field magnet, and each may be particularly a permanent magnet-type synchronous machine.

The two rotating electrical machines are respectively connected to two of three elements of a planetary gear mechanism 18, and the other one element is connected to drive wheels. In the embodiment, the rotating electrical machine 14 is connected to a ring gear 20 of the planetary gear mechanism 18, and the other rotating electrical machine 16 is connected to a sun gear 22. Hereinafter, the rotating electrical machine that is connected to the ring gear 20 is referred to as the first rotating electrical machine 14, and the rotating electrical machine that is connected to the sun gear 22 is referred to as the second rotating electrical machine 16. A carrier 26, that is, a third element of the planetary gear mechanism 18, serves as an output element. The third element supports planetary pinions 24 that are in mesh with the ring gear 20 and the sun gear 22 such that the planetary pinions 24 are rotatable. For example, an output gear 28 is coupled to the carrier 26, and power is transmitted from the output gear 28 to the drive wheels via a gear train, a differential unit, and the like. In the case of carrying out regenerative braking, input from the carrier 26 is transmitted to at least one of the two rotating electrical machines, and electric power is generated.

A first clutch 30 is provided between an output shaft (crankshaft) of the internal combustion engine 12 and an output shaft (rotor shaft) of the first rotating electrical machine 14. By connecting the first clutch 30, the output shaft of the internal combustion engine 12 and the output shaft of the first rotating electrical machine 14 integrally rotate. By disconnecting the first clutch 30, the first rotating electrical machine 14 is able to operate independently of the internal combustion engine 12. A second clutch 32 and a brake 34 are provided between the first rotating electrical machine 14 and the ring gear 20. By connecting the second clutch 32, the first rotating electrical machine 14 and the ring gear 20 integrally rotate. On the other hand, when the second clutch 32 is disconnected, the ring gear 20 and the first rotating electrical machine 14 may be isolated from each other. By engaging the brake 34, it is possible to fix the ring gear 20 such that the ring gear 20 does not rotate.

The power unit 10 includes a control unit 36 that controls operations of the internal combustion engine 12, the first and second rotating electrical machines 14, 16, the first and second clutches 30, 32 and the brake 34. The control unit 36 acquires a driver's request, a travel state of the vehicle and an operating state of the power unit 10, and executes control on the basis of these pieces of information. The driver's request may be, for example, acquired on the basis of operation or operation amount of an operator conducted by a driver, such as an accelerator pedal 38 and a brake pedal 40. The travel state of the vehicle may be, for example, acquired by, for example; a vehicle speed sensor 41 that detects a travel speed of the vehicle. In addition, by comparing rotation speeds of wheels with one another, it is possible to also acquire, for example, information that the vehicle is travelling on a slippery road surface. The operating state of the power unit 10 may be acquired from various sensors provided at predetermined portions of the power unit 10. Examples of the sensors include a temperature sensor that detects a coolant temperature, a sensor that detects a pressure in an intake pipe of the internal combustion engine 12, a sensor that detects the concentration of oxygen, or the like, in exhaust gas, and the like. In addition, the state of charge of a secondary battery that supplies electric power to the two rotating electrical machines 14, 16 is also acquired as information that indicates the operating state of the power unit 10. A control device for the power unit 10 includes means for acquiring these pieces of information, which are input to the control unit 36, and the control unit 36.

The control device for the power unit 10 includes means for acquiring the temperature of the permanent magnet of the first rotating electrical machine 14 and the temperature of the permanent magnet of the second rotating electrical machine 16. The above means includes temperature sensors that respectively detect the temperature of coolant of the first rotating electrical machine 14 and the temperature of coolant of the second rotating electrical machine 16 and computing means for estimating the temperature of each permanent magnet on the basis of the temperature detected by the corresponding temperature sensor. The control unit 36 executes a predetermined process. Thus, the control unit 36 functions as the computing means for estimating the temperature of each permanent magnet.

In order to acquire the temperature of each permanent magnet, it is desirable to provide the corresponding temperature sensor such that the temperature sensor is directly in contact with the corresponding permanent magnet; however, this is not easy because of, for example, restrictions to layout. Particularly, in the case where the permanent magnet is arranged on the rotor of the rotating electrical machine, a configuration for receiving a signal from the rotor leads to a complex device, so it is not realistic to directly detect the temperature of the permanent magnet. In the embodiment, the temperature of the permanent magnet is estimated on the basis of the temperature of coolant, which correlates with the temperature of the permanent magnet. Lubricant may also be used as coolant. A temperature that may be used for estimation may be the temperature of the stator of the rotating electrical machine, for example, the temperature of a coil, other than the coolant temperature. A sensor for detecting the temperature of coolant is provided at each of the rotating electrical machines 14, 16. Hereinafter, the temperature sensor provided in correspondence with the first rotating electrical machine 14 is referred to as a first temperature sensor 42, and the temperature sensor provided in correspondence with the second rotating electrical machine 16 is referred to as a second temperature sensor 44. The correspondence relationship between the temperature detected by the first temperature sensor 42 and the permanent magnet temperature and the correspondence relationship between the temperature detected by the second temperature sensor 44 and the permanent magnet temperature are stored in the control unit 36 in advance as correspondence data tables. The control unit 36 calculates the temperature of each permanent magnet on the basis of the detected temperatures and the stored correspondence relationships.

The power unit 10 is able to implement various operation modes by controlling the operations of the first and second clutches 30, 32 and brake 34. One of the operation modes is a mode in which the power unit 10 is caused to function as a series hybrid. By disconnecting the second clutch 32, it is possible to operate the internal combustion engine 12 and the first rotating electrical machine 14 in a state where the internal combustion engine 12 and the first rotating electrical machine 14 are isolated from the drive wheels. By connecting the first clutch 30, it is possible to operate the first rotating electrical machine 14 as a generator by driving the first rotating electrical machine 14 with the use of the internal combustion engine 12. Generated electric power can be stored in the secondary battery (not shown). In addition, it is possible to propel the vehicle by driving the second rotating electrical machine 16 with the use of generated electric power. At this time, the ring gear 20 is fixed by engaging the brake 34.

In a mode in which the power unit 10 is caused to function as a parallel hybrid, the first and second clutches 30, 32 are connected, and the brake 34 is released. The internal combustion engine 12 is connected to the ring gear 20 via the first rotating electrical machine 14, and it is possible to drive the vehicle with the use of the internal combustion engine 12 and one or both of the first and second rotating electrical machines 14, 16. At this time, it is also possible to charge the secondary battery by causing the first rotating electrical machine 14 to operate as a generator.

Furthermore, when the power unit 10 is caused to operate in an electric mode, the second clutch 32 is disconnected, and the brake 34 is engaged. The vehicle is propelled by driving the second rotating electrical machine 16 with the use of electric power from the secondary battery. In addition, it is possible to drive the vehicle with the use of the first and second rotating electrical machines 14, 16. In this case, the first clutch 30 is disconnected, the second clutch 32 is connected, and the brake 34 is released.

FIG. 2 is a view that illustrates adjustment of outputs of the rotating electrical machines 14, 16 in the case of a temperature condition that demagnetization of the permanent magnet of one of the two rotating electrical machines 14, 16 occurs. Hereinafter, the case where demagnetization of the permanent magnet occurs in a high-temperature range will be described.

In FIG. 2, the ordinate axes respectively represent outputs of the three elements of the planetary gear mechanism 18. In the graph, the left-side S-axis represents the output of the second rotating electrical machine 16 that is connected to the sun gear 22, the middle C-axis represents the output of the carrier 26, and the right-side R-axis represents the output of the first rotating electrical machine 14 and/or the internal combustion engine 12 that is connected to the ring gear 20. The output at the R-axis is the total of the output of the first rotating electrical machine 14 and the output of the internal combustion engine 12. Hereinafter, for the sake of simplification, the case where only the first rotating electrical machine 14 outputs power will be described.

Outputs of the three elements at certain time point are present on a straight line that crosses the ordinate axes of FIG. 2. That is, the outputs of the first and second rotating electrical machines 14, 16 for setting the output of the carrier 26 to a certain value are indicated by intersections (for example, points R1, Sl, points R2, S3) of a straight line (for example, straight line ml or straight line m3) that passes through a point (for example, point C1) at the C-axis, indicating the certain value of the output of the carrier 26, with the S-axis and the R-axis. Thus, there are an infinite number of combinations of the outputs of the first and second rotating electrical machines 14, 16 for setting the output of the carrier 26 to a certain value.

When the temperature of the permanent magnet of one of the rotating electrical machines, for example, the first rotating electrical machine 14, exceeds a predetermined temperature that is set as a condition that demagnetization occurs or becomes close to the predetermined temperature, the output of the first rotating electrical machine 14 is decreased to a value at which demagnetization does not occur, and the output of the other rotating electrical machine 16 is increased. It is desirable that the amount of increase in the output of the second rotating electrical machine 16 be determined such that the output of the carrier 26 is kept.

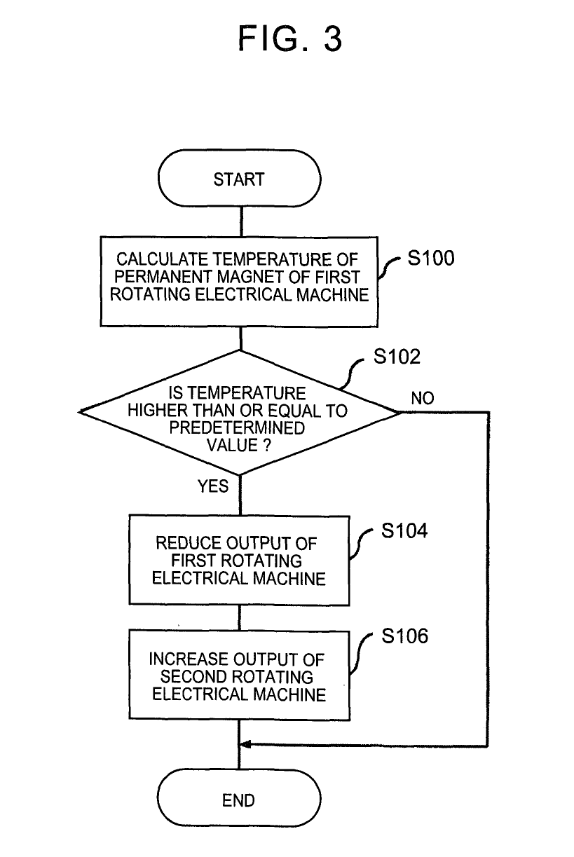

FIG. 3 is a flowchart of a process of preventing demagnetization of the permanent magnet, which is executed in the control unit 36. In an initial stage, the outputs (R1, C1, S1) of the three elements of the planetary gear mechanism 18 are present on the straight line m1. The temperature of the permanent magnet of the first rotating electrical machine 14 is calculated on the basis of a signal from the first temperature sensor 42 (S100). It is determined whether the calculated temperature is higher than or equal to a predetermined value (S102). When negative determination is made, the process ends. When the temperature is higher than or equal to the predetermined value, the output of the first rotating electrical machine is reduced from R1 to R2 (S104). The correlation between an amount of reduction and a calculated temperature is determined in advance. In order to compensate for the reduction in the output of the first rotating electrical machine 14, the output of the second rotating electrical machine 16 is increased from S1 to S3 (S106). The output C1 of the carrier 26 is kept by increasing the output of the second rotating electrical machine 16 to S3.

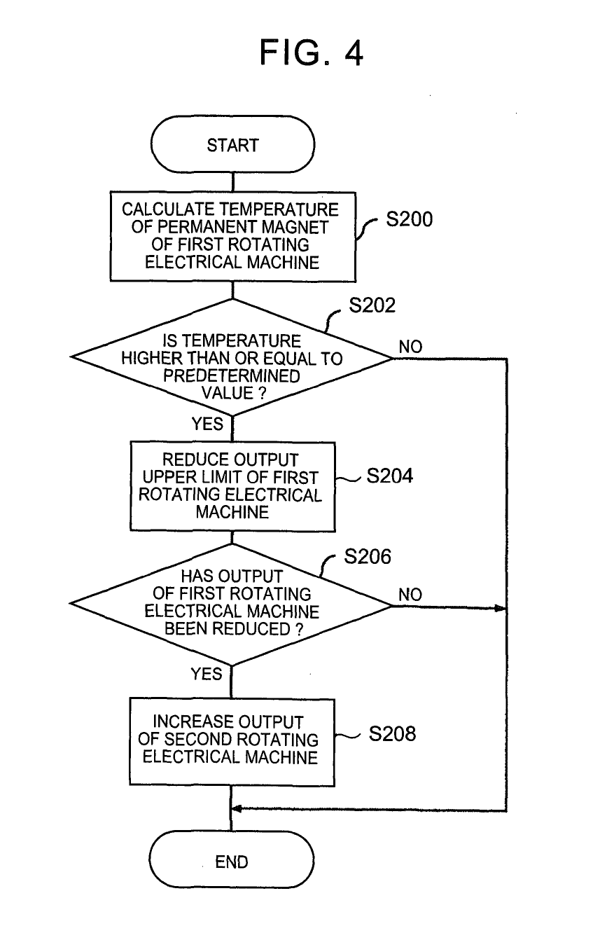

FIG. 4 is a flowchart of another example of a process of preventing demagnetization. In an initial stage, the outputs (R1, C1, S1) of the three elements of the planetary gear mechanism 18 are present on the straight line m1. The temperature of the permanent magnet of the first rotating electrical machine 14 is calculated on the basis of a signal from the first temperature sensor 42 (S200). It is determined whether the calculated temperature is higher than or equal to a predetermined value (S202). When negative determination is made, the process ends. When the temperature is higher than or equal to the predetermined value, an output upper limit of the first rotating electrical machine 14 is decreased (S204). The output upper limit is an upper limit of output at or below which demagnetization does not occur at the calculated temperature, and the output of the first rotating electrical machine 14 is constantly controlled to at or below the upper limit. When the output of the first rotating electrical machine 14, which is calculated on the basis of another condition, such as a driver's request, becomes higher than or equal to the upper limit, the output of the first rotating electrical machine 14 is reduced to the upper limit. It is determined whether the output of the first rotating electrical machine 14 has been reduced (S206). When negative determination is made, the process ends. When the output of the first rotating electrical machine 14 has been reduced from R1 to R2, the output of the second rotating electrical machine 16 is increased from S1 to S3 (S208). The output C1 of the carrier 26 is kept by increasing the output of the second rotating electrical machine 16 to S3.

The above-described two process flowcharts show processes in the case where the temperature of the permanent magnet of the first rotating electrical machine 14 rises. However, these process flowcharts are also applicable to the case where the temperature of the permanent magnet of the second rotating electrical machine 16 rises, and it is possible to compensate for an output reduced in the second rotating electrical machine 16 with the use of the first rotating electrical machine 14.

In the above-described embodiment, the two rotating electrical machines each are the permanent magnet-type rotating electrical machine. However, it is also possible to similarly execute control in a power unit in which one of the two rotating electrical machines is a rotating electrical machine that does not use a permanent magnet, such as a reluctance-type rotating electrical machine and an induction rotating electrical machine. That is, it may be implemented as follows. The temperature of the permanent magnet of the permanent magnet-type rotating electrical machine between the two rotating electrical machines is acquired. When the temperature exceeds a temperature at which demagnetization occurs or becomes close to the temperature, the output of the permanent magnet-type rotating electrical machine is reduced, and the decreased output is compensated by the output of the rotating electrical machine that does not use a permanent magnet.

Each temperature sensor for acquiring the temperature of the corresponding permanent magnet may be a sensor that detects the temperature of another portion, such as a coil of the rotating electrical machine.

In addition, which elements of the planetary gear mechanism are respectively connected to the two rotating electrical machines and the drive wheels are not limited to the above-described embodiment, and may be selected.

1. A control device for a hybrid vehicle power unit that includes a first rotating electrical machine connected to a first element of a planetary gear mechanism, a second rotating electrical machine connected to a second element of the planetary gear mechanism and an internal combustion engine connected to the first rotating electrical machine, a third element of the planetary gear mechanism being connected to a drive wheel, the control device comprising:
a temperature acquisition unit configured to acquire a temperature of a permanent magnet of at least one of the first rotating electrical machine or the second rotating electrical machine; and
an electronic control unit configured to reduce an output of one of the rotating electrical machines when the acquired temperature falls outside a predetermined range and that increases an output of the other one of the rotating electrical machines, the one of the rotating electrical machines including the permanent magnet of which the temperature falls outside the predetermined range.

2. The control device according to claim 1, wherein
the output of the one of the rotating electrical machines is reduced by reducing an output upper limit value of the one of the rotating electrical machines.

3. A control device for a hybrid vehicle power unit that includes a first rotating electrical machine connected to a first element of a planetary gear mechanism, a second rotating electrical machine connected to a second element of the planetary gear mechanism and an internal combustion engine connected to the first rotating electrical machine, a third element of the planetary gear mechanism being connected to a drive wheel, the control device comprising:
a temperature acquisition unit configured to acquire a temperature of a permanent magnet of at least one of the first rotating electrical machine or the second rotating electrical machine; and
an electronic control unit configured to reduce an output upper limit value of one of the rotating electrical machines when the acquired temperature falls outside a predetermined range and that increases an output of the other one of the rotating electrical machines when the output of the one of the rotating electrical machines has been reduced by reducing the output upper limit value, the one of the rotating electrical machines including the permanent magnet of which the temperature falls outside the predetermined range.

4. A control method for a hybrid vehicle power unit that includes a first rotating electrical machine connected to a first element of a planetary gear mechanism, a second rotating electrical machine connected to a second element of the planetary gear mechanism, an internal combustion engine connected to the first rotating electrical machine, a third element of the planetary gear mechanism being connected to a drive wheel, and an electronic control unit, the control method comprising:
acquiring, by the electronic control unit, a temperature of a permanent magnet of at least one of the first rotating electrical machine or the second rotating electrical machine; and
when the acquired temperature falls outside a predetermined range, reducing, by the electronic control unit, an output of one of the rotating electrical machines, which includes the permanent magnet of which the temperature falls outside the predetermined range, and increasing, by the electronic control unit, an output of the other one of the rotating electrical machines.
